(19) United States
(12) Patent Application Publication
(10) Pub. No.: US 2026/0150017 A1
(43) Pub. Date: May 28, 2026

(54) CONDITIONAL HANDOVER

(71) Applicant: Nokia Technologies Oy, Espoo (FI)

(72) Inventors: Umur KARABULUT, Munich (DE); Amaanat ALI, Espoo (FI); Ahmad AWADA, Munich (DE); Halit Murat GÜRSU, Munich (DE); Subramanya CHANDRASHEKAR, Bangalore (IN); Srinivasan SELVAGANAPATHY

(21) Appl. No.: 19/100,593

(22) PCT Filed: Jun. 13, 2023
(86) PCT No.: PCT/EP2023/065749

§ 371 Date: Feb. 3, 2025

(30) Foreign Application Priority Data
Aug. 2, 2022 (IN) 202241044245

(51) Int. Cl. H04W 36/00; H04W 36/08

(52) U.S. Cl. CPC H04W 36/0072; H04W 36/0064; H04W 36/08

(57) ABSTRACT

A user equipment comprising: at least one processor; and at least one memory including computer program code, the at least one memory storing instructions that, when executed by the at least one processor, cause the user equipment, UE, at least to: establish a connection towards a primary cell of a master node; receive configuration information comprising information to allow the UE to conditionally handover the connection from the primary cell towards a target primary cell and further information to allow the UE to access a plurality of target primary secondary cells associated with the target primary cell and at least one associated access condition; determine that a handover execution condition for the target primary cell is satisfied; establish a connection towards the target primary cell; send, based at least in part on at least a portion of the further information, an access request towards a first target primary secondary cell of the plurality of target primary secondary cells; and maintain, after sending the access request towards the first target primary secondary cell, at least part of the further information to allow the UE to access at least one target primary secondary cell different to the first target primary secondary cell.

### TECHNOLOGICAL FIELD

Examples of the disclosure relate to conditional handover. Some relate to conditional handover with dual connectivity configuration.

### BACKGROUND

A wireless network comprises a plurality of network nodes including terminal nodes and access nodes. Communication between the terminal nodes and access nodes is wireless.

In some circumstances it may be desirable to improve or enhance conditional handover with a target dual connectivity configuration.

### BRIEF SUMMARY

According to various, but not necessarily all, embodiments there is provided a user equipment comprising:
at least one processor; and
at least one memory including computer program code,
the at least one memory storing instructions that, when executed by the at least one processor, cause the user equipment, UE, at least to:
establish a connection towards a primary cell of a master node;
receive configuration information comprising information to allow the UE to conditionally handover the connection from the primary cell towards a target primary cell and further information to allow the UE to access a plurality of target primary secondary cells associated with the target primary cell and at least one associated access condition;
determine that a handover execution condition for the target primary cell is satisfied;
establish a connection towards the target primary cell;
send, based at least in part on at least a portion of the further information, an access request towards a first target primary secondary cell of the plurality of target primary secondary cells; and
maintain, after sending the access request towards the first target primary secondary cell, at least part of the further information to allow the UE to access at least one target primary secondary cell different to the first target primary secondary cell.

In some examples, sending an access request towards the first target primary secondary cell comprises sending a random access request towards the first target primary secondary cell.

In some examples, the at least one memory storing instructions that, when executed by the at least one processor, cause the apparatus at least to:
determine that access towards the first target primary secondary cell has failed; and
send, based at least in part on at least a portion of the further information that was maintained after sending the access request towards the first target primary secondary cell, an access request towards a second, different target primary secondary cell.

In some examples, the at least one memory storing instructions that, when executed by the at least one processor, cause the apparatus at least to:
when the handover execution condition for the target primary cell is satisfied, determine that none of the associated access conditions of the plurality of target primary secondary cells are satisfied; and
select a target primary secondary cell to be used as the first target primary secondary cell.

In some examples, the further information comprises a plurality of configurations configured to allow the UE to conditionally access a plurality of target primary secondary cells, wherein the plurality of configurations have associated release and add indications.

In some examples, the plurality of configurations configured to allow the UE to conditionally access the plurality of target primary secondary cells comprise full configurations.

In some examples, the plurality of configurations configured to allow the UE to conditionally access the plurality of target primary secondary cells comprise delta configurations configured to be applied on a reference primary secondary cell configuration to obtain a full configuration.

In some examples, the at least one memory storing instructions that, when executed by the at least one processor, cause the apparatus at least to:
receive an indication that the current primary secondary cell configuration should be maintained as a reference primary secondary cell configuration after sending the access request towards the first target primary secondary cell.

In some examples, the indication comprises the current primary secondary cell configuration.

According to various, but not necessarily all, embodiments there is provided a method comprising:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition;
determining that a handover execution condition for the target primary cell is satisfied;
establishing a connection towards the target primary cell;
sending, based at least in part on at least a portion of the further information, an access request towards a first target primary secondary cell of the plurality of target primary secondary cells; and
maintaining, after sending the access request towards the first target primary secondary cell, at least part of the further information to allow the UE to access at least one target primary secondary cell different to the first target primary secondary cell.

In some examples, sending an access request towards the first target primary secondary cell comprises sending a random access request towards the first target primary secondary cell.

In some examples, the method comprises:
determining that access towards the first target primary secondary cell has failed; and
sending, based at least in part on at least a portion of the further information that was maintained after sending the access request towards the first target primary secondary cell, an access request towards a second, different target primary secondary cell.

In some examples, the method comprises:
when the handover execution condition for the target primary cell is satisfied, determining that none of the associated access conditions of the plurality of target primary secondary cells are satisfied; and
selecting a target primary secondary cell to be used as the first target primary secondary cell.

In some examples, the further information comprises a plurality of configurations configured to allow the UE to conditionally access a plurality of target primary secondary cells, wherein the plurality of configurations have associated release and add indications.

In some examples, the plurality of configurations configured to allow the UE to conditionally access the plurality of target primary secondary cells comprise full configurations.

In some examples, the plurality of configurations configured to allow the UE to conditionally access the plurality of target primary secondary cells comprise delta configurations configured to be applied on a reference primary secondary cell configuration to obtain a full configuration.

In some examples, the method comprises:
receiving an indication that the current primary secondary cell configuration should be maintained as a reference primary secondary cell configuration after sending the access request towards the first target primary secondary cell.

In some examples, the indication comprises the current primary secondary cell configuration.

According to various, but not necessarily all, embodiments there is provided a computer program comprising instructions for causing an apparatus to perform at least the following:
establishing a connection towards a primary cell of a master node;
receiving configuration information comprising information to allow the UE to conditionally handover the connection from the primary cell towards a target primary cell and further information to allow the UE to access of a plurality of target primary secondary cells associated with the target primary cell and at least one associated access condition;
determining that a handover execution condition for the target primary cell is satisfied;
establishing a connection towards the target primary cell;
sending, based at least in part on at least a portion of the further information, an access request towards a first target primary secondary cell of the plurality of target primary secondary cells; and
maintaining, after sending the access request towards the first target primary secondary cell, at least part of the further information to allow the UE to access at least one target primary secondary cell different to the first target primary secondary cell.

In some examples, sending an access request towards the first target primary secondary cell comprises sending a random access request towards the first target primary secondary cell.

In some examples, the computer program comprising instructions for causing an apparatus to perform at least the following:
determining that access towards the first target primary secondary cell has failed; and
sending, based at least in part on at least a portion of the further information that was maintained after sending the access request towards the first target primary secondary cell, a access request towards a second, different target primary secondary cell.

In some examples, the computer program comprising instructions for causing an apparatus to perform at least the following:
when the handover execution condition for the target primary cell is satisfied, determining that none of the associated access conditions of the plurality of target primary secondary cells are satisfied; and
selecting a target primary secondary cell to be used as the first target primary secondary cell.

In some examples, the further information comprises a plurality of configurations configured to allow the UE to conditionally access a plurality of target primary secondary cells, wherein the plurality of configurations have associated release and add indications.

In some examples, the plurality of configurations configured to allow the UE to conditionally access the plurality of target primary secondary cells comprise full configurations.

In some examples, the plurality of configurations configured to allow the UE to conditionally access the plurality of target primary secondary cells comprise delta configurations configured to be applied on a reference primary secondary cell configuration to obtain a full configuration.

In some examples, the computer program comprising instructions for causing an apparatus to perform at least the following:
receiving an indication that the current primary secondary cell configuration should be maintained as a reference primary secondary cell configuration after sending the random access request towards the first target primary secondary cell.

In some examples, the indication comprises the current primary secondary cell configuration.

According to various, but not necessarily all, embodiments there is provided an apparatus comprising:
at least one processor; and
at least one memory including computer program code,
the at least one memory storing instructions that, when executed by the at least one processor, cause the apparatus at least to:
establish a connection towards a user equipment, UE, via a source primary cell;
determine that conditional handover is to be configured at the UE;
transmit, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmit, to the UE, an indication that the current primary secondary cell configuration should be maintained as a reference primary secondary cell configuration after sending an access request towards a first target primary secondary cell.

In some examples, the indication comprises the current primary secondary cell configuration.

According to various, but not necessarily all, embodiments there is provided a method comprising:
establishing a connection towards a user equipment, UE, via a source primary cell;
determining that conditional handover is to be configured at the UE;
transmitting, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmitting, to the UE, an indication that the current primary secondary cell configuration should be maintained as a reference primary secondary cell configuration after sending a access request towards a first target primary secondary cell.

In some examples, the indication comprises the current primary secondary cell configuration.

According to various, but not necessarily all, embodiments there is provided a computer program comprising instructions for causing an apparatus to perform at least the following:

Establishing a connection towards a user equipment, UE, via a source primary cell;
determining that conditional handover is to be configured at the UE;
transmitting, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmitting, to the UE, an indication that the current primary secondary cell configuration should be maintained as a reference primary secondary cell configuration after sending a access request towards a first target primary secondary cell.

In some examples, the indication comprises the current primary secondary cell configuration.

According to various, but not necessarily all embodiments, there is provided a user equipment comprising:
at least one processor; and
at least one memory including computer program code,
the at least one memory storing instructions that, when executed by the at least one processor, cause the user equipment, UE, at least to:
establish a connection towards a primary cell of a master node;
receive configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determine that a handover execution condition for the target primary cell is satisfied and that none of the conditions to access the plurality of target primary secondary cells are satisfied;
establish a connection towards the target primary cell; and
apply the reference primary secondary cell configuration.

In some examples, the at least one memory storing instructions that, when executed by the at least one processor, cause the apparatus at least to:
if it is determined at a later time that a condition to access a first target primary secondary cell of the plurality of target primary secondary cells is satisfied, apply a first delta configuration of the plurality of delta configurations to the reference primary secondary cell configuration to access the first target primary secondary cell of the plurality of target primary secondary cells.

In some examples, the at least one memory storing instructions that, when executed by the at least one processor, cause the apparatus at least to:
receive the reference primary secondary cell configuration, wherein the reference primary secondary cell configuration has been determined by a target secondary node.

According to various, but not necessarily all, embodiments there is provided a method comprising:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determining that a handover execution condition for the target primary cell is satisfied and that none of the conditions to access the plurality of target primary secondary cells are satisfied;
establishing a connection towards the target primary cell; and
applying the reference primary secondary cell configuration.

In some examples, the method comprises:
if it is determined at a later time that a condition to access a first target primary secondary cell of the plurality of target primary secondary cells is satisfied, applying a first delta configuration of the plurality of delta configurations to the reference primary secondary cell configuration to access the first target primary secondary cell of the plurality of target primary secondary cells.

In some examples, the method comprises:
receiving the reference primary secondary cell configuration, wherein the reference primary secondary cell configuration has been determined by a target secondary node.

According to various, but not necessarily all, embodiments there is provided a computer program comprising instructions for causing an apparatus to perform at least:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determining that a handover execution condition for the target primary cell is satisfied and that none of the conditions to access the plurality of target primary secondary cells are satisfied;
establishing a connection towards the target primary cell; and
applying the reference primary secondary cell configuration.

In some examples, the computer program comprising instructions for causing an apparatus to perform at least the following:
if it is determined at a later time that a condition to access a first target primary secondary cell of the plurality of target primary secondary cells is satisfied, applying a first delta configuration of the plurality of delta configurations to the reference primary secondary cell configuration to access the first target primary secondary cell of the plurality of target primary secondary cells.

In some examples, the computer program comprising instructions for causing an apparatus to perform at least the following:
receiving the reference primary secondary cell configuration, wherein the reference primary secondary cell configuration has been determined by a target secondary node.

According to various, but not necessarily all, embodiments there is provided an apparatus comprising:
at least one processor; and
at least one memory including computer program code,
the at least one memory storing instructions that, when executed by the at least one processor, cause the apparatus at least to:
request a target secondary node to determine a reference primary secondary cell configuration;
receive the reference primary secondary cell configuration from the target secondary node; and
request at least one different target secondary node to determine a delta configuration, relative to the reference primary secondary cell configuration, configured to allow a UE to access at least one target primary secondary cell associated with the at least one different target secondary node; and
receive at least one requested delta configuration from the at least one different target secondary node.

In some examples, the at least one memory storing instructions that, when executed by the at least one processor, cause the apparatus at least to:
transmit the received at least one requested delta configuration and the reference primary secondary cell configuration to a source master node.

According to various, but not necessarily all, embodiments there is provided a method comprising:
requesting a target secondary node to determine a reference primary secondary cell configuration;
receiving the reference primary secondary cell configuration from the target secondary node; and
requesting at least one different target secondary node to determine a delta configuration, relative to the reference primary secondary cell configuration, configured to allow a UE to access at least one target primary secondary cell associated with the at least one different target secondary node; and
receiving at least one requested delta configuration from the at least one different target secondary node.

In some examples, the method comprises:
transmitting the received at least one requested delta configuration and the reference primary secondary cell configuration to a source master node.

According to various, but not necessarily all, embodiments there is provided a computer program comprising instructions for causing an apparatus to perform at least the following:
requesting a target secondary node to determine a reference primary secondary cell configuration;
receiving the reference primary secondary cell configuration from the target secondary node; and
requesting at least one different target secondary node to determine a delta configuration, relative to the reference primary secondary cell configuration, configured to allow a UE to access at least one target primary secondary cell associated with the at least one different target secondary node; and
receiving at least one requested delta configuration from the at least one different target secondary node.

In some examples, the computer program comprising instructions for causing an apparatus to perform at least the following:
transmitting the received at least one requested delta configuration and the reference primary secondary cell configuration to a source master node.

According to various, but not necessarily all, embodiments there is provided an apparatus comprising:
at least one processor; and
at least one memory including computer program code,
the at least one memory storing instructions that, when executed by the at least one processor, cause the apparatus at least to:
establish a connection towards a user equipment, UE, via a source primary cell;
determine configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
transmit the configuration information to the UE.

In some examples, the reference primary secondary cell configuration has been determined by a target secondary node.

According to various, but not necessarily all, embodiments there is provided a method comprising:
establishing a connection towards a user equipment, UE, via a source primary cell;
determining configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
transmitting the configuration information to the UE.

In some examples, the reference primary secondary cell configuration has been determined by a target secondary node.

According to various, but not necessarily all, embodiments there is provided a computer program comprising instructions for causing an apparatus to perform at least the following:
establish a connection towards a user equipment, UE, via a source primary cell;
determine configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
transmit the configuration information to the UE.

In some examples, the reference primary secondary cell configuration has been determined by a target secondary node.

According to various, but not necessarily all, embodiments there is provided an apparatus comprising:
at least one processor; and
at least one memory including computer program code,
the at least one memory storing instructions that, when executed by the at least one processor, cause the apparatus at least to perform at least part of one or more methods disclosed herein.

According to various, but not necessarily all, embodiments there is provided an apparatus comprising means for performing at least part of one or more methods disclosed herein.

According to various, but not necessarily all, examples there is provided examples as claimed in the appended claims.

The description of a function should additionally be considered to also disclose any means suitable for performing that function.

### BRIEF DESCRIPTION

Some examples will now be described with reference to the accompanying drawings in which:

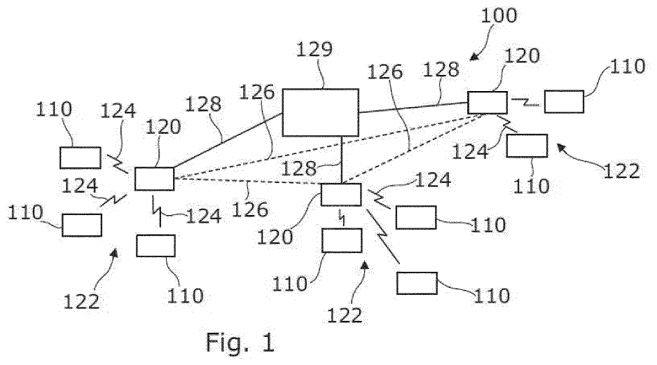

FIG. 1 shows an example of the subject matter described herein;

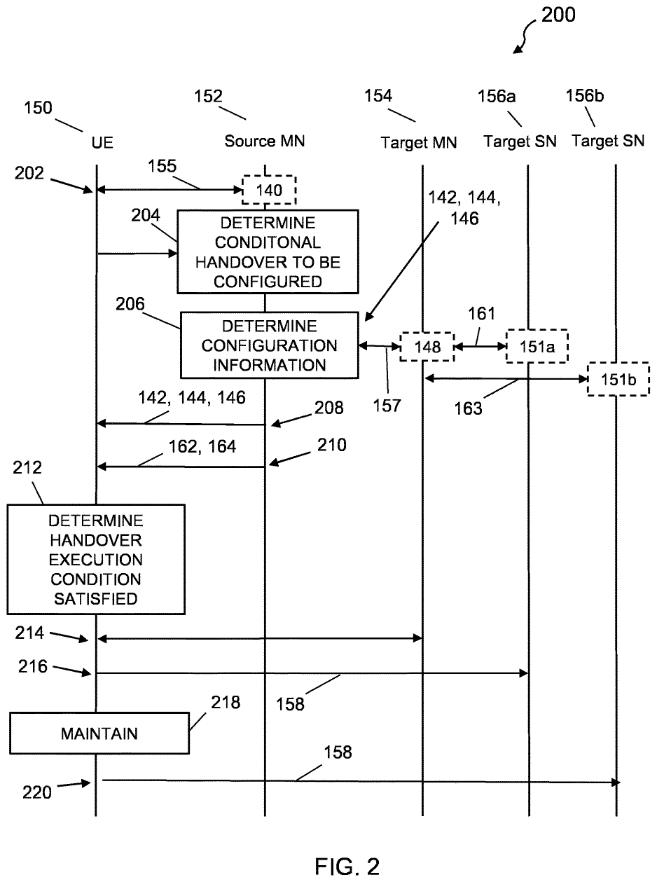

FIG. 2 shows another example of the subject matter described herein;

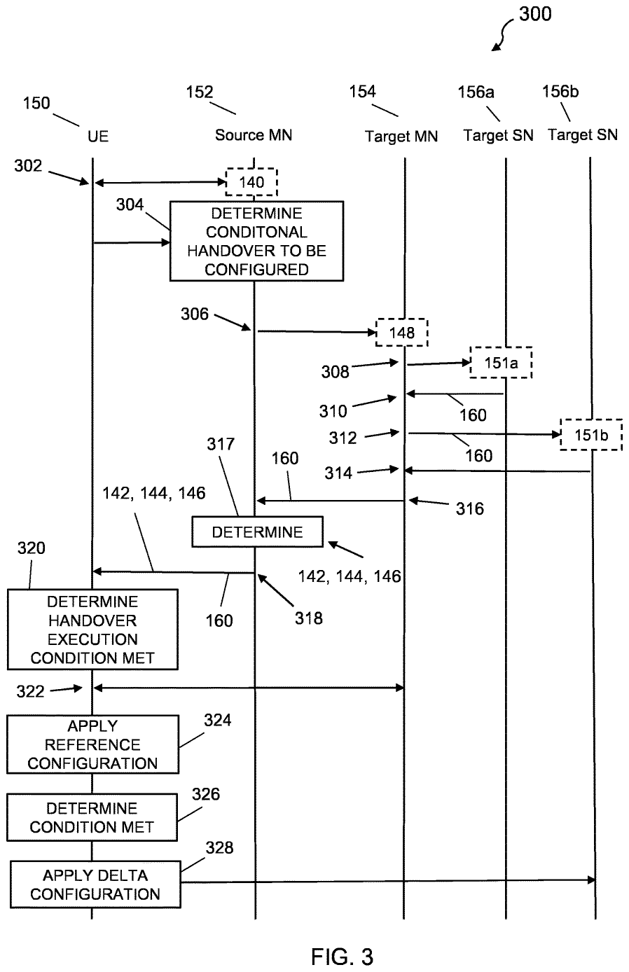

FIG. 3 shows another example of the subject matter described herein;

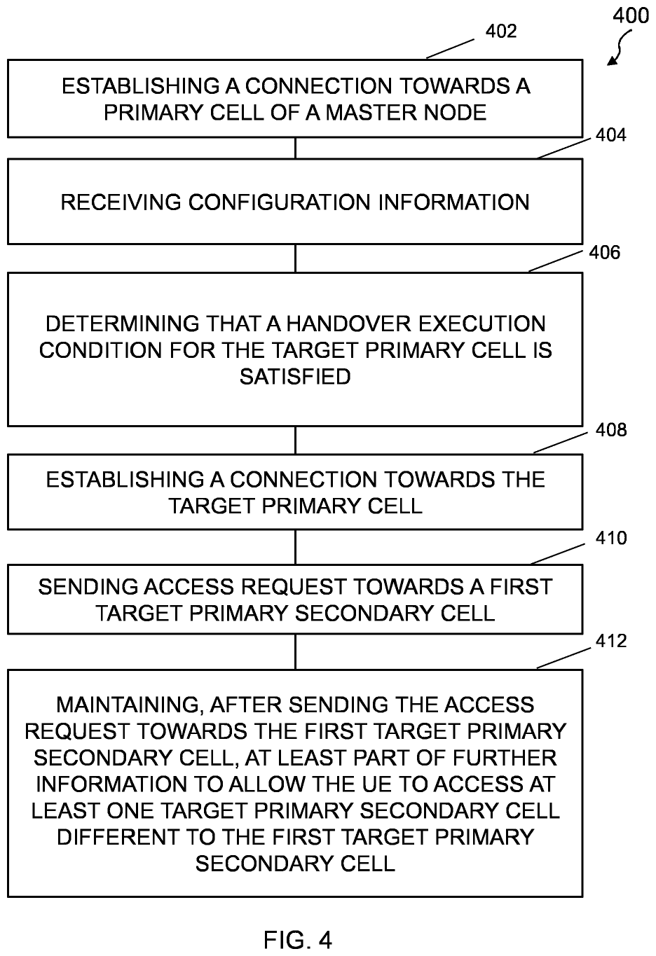

FIG. 4 shows another example of the subject matter described herein;

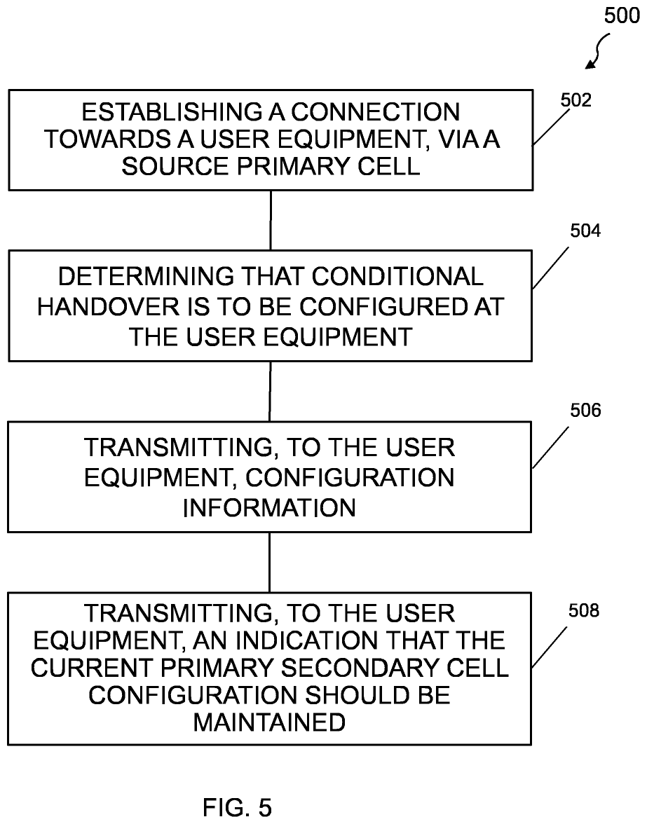

FIG. 5 shows another example of the subject matter described herein;

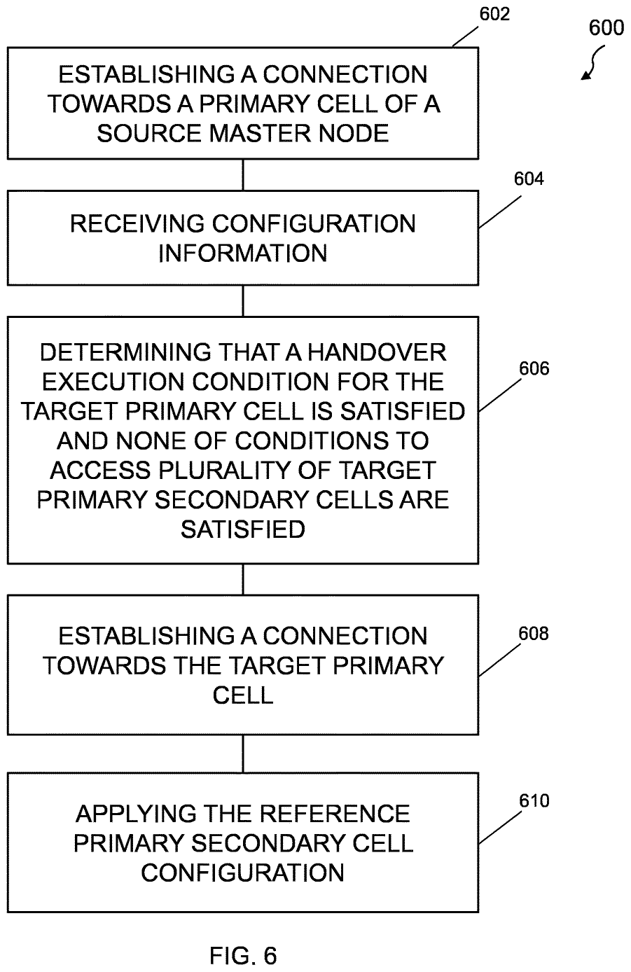

FIG. 6 shows another example of the subject matter described herein;

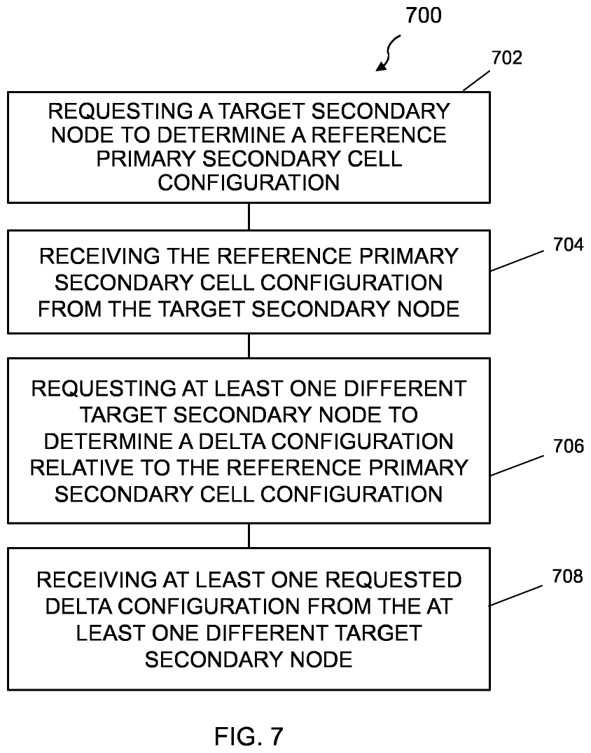

FIG. 7 shows another example of the subject matter described herein;

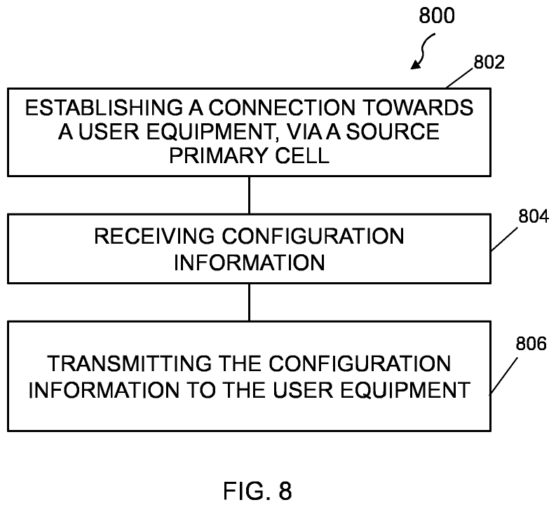

FIG. 8 shows another example of the subject matter described herein;

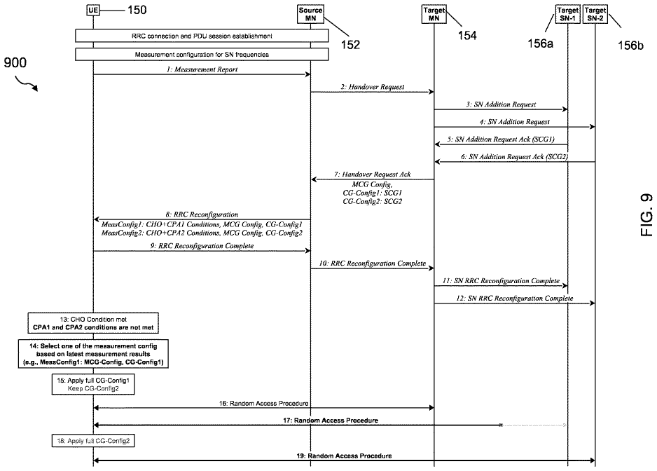

FIG. 9 shows another example of the subject matter described herein;

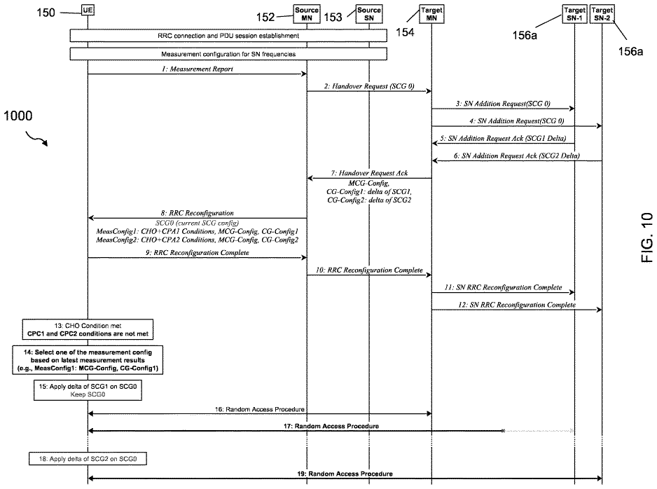

FIG. 10 shows another example of the subject matter described herein;

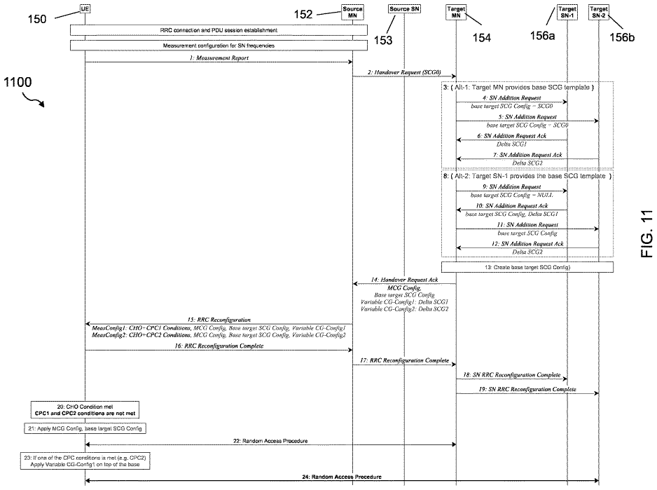

FIG. 11 shows another example of the subject matter described herein;

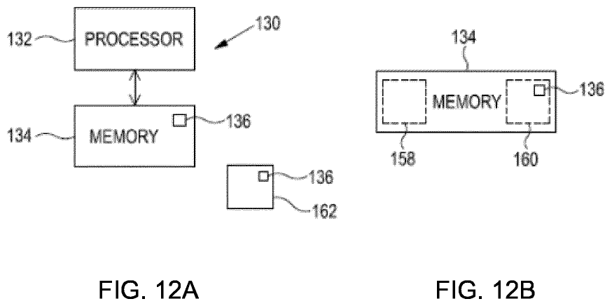

FIG. 12A shows another example of the subject matter described herein; and

FIG. 12B shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DEFINITIONS

Master Node (MN): Network node that provides control plane connectivity towards the core network.

Master Cell Group (MCG): Group of cells associated with the MN, includes PCell and SCell(s).

Secondary Node (SN): Network node that is providing additional radio resources for the UE but is not the MN.

Secondary Cell Group (SCG): Group of cells associated with the SN, includes PSCell and SCells.

Pcell: The cell for uplink/downlink connection to MN. Cell of MCG used to initiate initial access to the MN.

PSCell: the cell for uplink/downlink connection to SN. Cell of SCG used to initiate initial access to the SN.

Conditional Handover (CHO)—a handover procedure that is triggered by the UE only when the configured execution condition(s) are met for a prepared candidate cell. Condition(s) are pre-configured by network. In 3GPP, a conditional handover execution condition is specified by condExecutionCond within the CondReconfig ToAddModList information element within the ConditionalReconfiguration information element within an RRCReconfiguration message.

### Dual Connectivity (DC):

UE has contemporaneous connection to an MN and an SN. This is a mode of operation of a UE in RRC_CONNECTED, configured with a Master Cell Group and a Secondary Cell Group.

### Configuration Information:

Information used to configure operation of a UE. In 3GPP, the configuration information can, for example, be provided in an RRCReconfiguration message. The term “configuration information comprising” and entity (for example handover execution condition for a primary cell; SN addition condition for dual connectivity with the primary cell and so on) can mean that the configuration information comprises information sufficient to obtain the entity. It may or may not comprise all parameters of the entity, it may instead comprise pointer to the entity or parameters of the entity or can mean that configuration includes the entity.

### Conditional Handover (CHO) Configuration Information

Configuration information for handover to a primary cell. The CHO configuration information can comprise a handover execution condition for a primary cell and a measurement configuration for configuring measurements for a handover execution condition for the primary cell. Triggering conditional handover to the primary cell is dependent upon the measurements meeting the handover execution condition for the primary cell.

In 3GPP, a RRCReconfiguration message specifies a ConditionalReconfiguration information element which provides the CHO configuration. The ConditionalReconfiguration information element comprises a CondReconfig ToAddModList information element. The CondReconfig ToAddModList information element comprises condExecutionCond and condRRCReconfig. Handover execution condition(s) for a primary cell are specified by condExecutionCond. The RRCReconfiguration message to be applied when the specified conditions are met is provided by condRRCReconfig.

### Dual Connectivity (DC) Configuration Information

Configuration information for dual connectivity to a primary secondary cell (PSCell). The DC configuration information can comprise an addition condition for a primary secondary cell for dual connectivity with the primary cell and a measurement configuration for configuring measurements for an addition condition for the primary secondary cell for dual connectivity with the primary cell, that is, dual connectivity of the UE with both the primary cell and the primary secondary cell.

Triggering addition of a primary secondary cell for dual connectivity is dependent upon the measurements meeting the addition condition for the primary secondary cell.

In 3GPP, a RRCReconfiguration message specifies a ConditionalReconfiguration information element which provides addition/change conditions for the DC. The ConditionalReconfiguration information element comprises a CondReconfig ToAddModList information element. The CondReconfig ToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In examples the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110.

The gNBs 120 are interconnected with each other by means of an X2/Xn interface 126. The gNBs are also connected by means of the N2 interface 128 to the Access and Mobility management Function (AMF).

In examples, the network 100 can comprise a combination of E-UTRAN and NG-RAN.

A user equipment comprises a mobile equipment. Where reference is made to user equipment that reference includes and encompasses, wherever possible, a reference to mobile equipment.

A UE 150, see for example FIG. 2, can perform a handover procedure to change the serving cell of the UE 150. In examples, a handover procedure can be a conditional handover procedure.

A conditional handover (CHO) procedure can be considered a handover that is triggered by the UE 150 when one or more handover execution conditions are met. The handover execution condition or conditions can be pre-configured by the network 100.

In examples, the UE 150 starts evaluating the execution condition(s) for CHO candidate cells upon receiving a CHO configuration, and executes the handover command once the execution condition(s) are met for a CHO candidate cell. The UE 150 may stop evaluating the execution condition(s) for other candidate cells once the execution condition(s) are met for a candidate cell.

In examples, a UE 150 can be provided with additional radio resources using dual connectivity (DC).

In DC, the configured set of serving cells for a UE 150 has two subsets: the Master Cell Group (MCG) containing the serving cells of a Master Node (MN) 152, and the Secondary Cell Group (SCG) containing the serving cells of a Secondary Node (SN) 153.

In examples, a conditional handover with dual connectivity can be configured. A UE 150 can be configured with execution condition(s) for CHO to one or more target MN 154 and execution condition(s) for handover to one or more target SN 156.

In examples, a terminal node 110, such as a UE 150, can be configured to efficiently manage and can efficiently manage conditional handover with dual connectivity.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGs.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, and four access nodes 120 transmit and/or receive one or more signals and/or one or more messages. In the example of FIG. 2 the terminal node 110 is a UE 150 and the four access nodes 120 are a source MN 152, a target MN 154, and two target SNs 156a, 156b.

In examples (not illustrated in FIG. 2) the UE 150 can also be connected to a source SN.

In examples, communications and/or transmissions between elements illustrated in FIG. 2 can proceed via any number of intervening elements, including no intervening elements.

Although one UE 150 is illustrated in the example of FIG. 2, in examples any suitable number of UEs 150 can be included.

Similarly, in examples, any suitable number of network nodes can be included.

In examples, method 200 and/or one or more parts of method 200 can be considered a method of enhancing conditional handover.

In examples, method 200 and/or one or more parts of method 200 can be considered a method of enhancing conditional handover with dual connectivity.

In examples, method 200 and/or one or more parts of method 200 can be considered a method of enhancing conditional handover with multiple PSCell preparations.

In the illustrated example, the location of the blocks indicates the entity performing the action(s). For example, block 204 is performed at/by the source MN 152.

At block 202, method 200 comprises, from the point of view of the source MN 152, establishing a connection towards a user equipment, UE 150, via a source primary cell 140 (PCell of source MN 152).

In some examples, the source MN 152 can be considered a source MN 152 when the connection towards the UE 150 has been established.

From the point of view of the UE 150, block 202 comprises establishing a connection towards a primary cell of a master node 152.

This is illustrated in the example of FIG. 2, by the double headed arrow 155 between the UE 150 and source MN 152.

Accordingly, it can be considered that block 202 comprises establishing a connection between a UE 150 and a source MN 152.

In examples, the source MN 152 can be considered a source MN 152 when the connection towards the UE 150 has been established.

Accordingly, in example, block 202 can be considered to comprise establishing a connection between a UE 150 and a network, such as an access node 120, which can be considered a source MN 152 when the connection has been established.

In some examples, establishing a connection comprises establishing an active radio link.

In some examples, establishing a connection comprises transmitting and/or receiving one or more signals.

In some examples, establishing a connection comprises performing an access procedure, such as a random access procedure. For example, the UE 150 can perform a random access process with the source MN 152 to establish a connection towards the source MN 152.

Establishing a connection between the UE 150 and source MN 152 can, for example, result in
direct access of the UE 150 to the source MN 152;
establishment of a radio link between the UE 150 and the source MN 152/source primary cell that enables the transfer of data via uplink (UL) and/or downlink (DL). The radio link can, for example, be established by initiating a RACH procedure at the UE 150;
traffic flow via bearer between the UE 150 and the network via source MN 152/source primary cell.

At block 204, method 200 comprises determining that a conditional handover is to be configured at the UE 150.

In examples, determining that a conditional handover is to be configured at the UE 150 can be considered determining that a conditional handover is to be prepared and/or arranged at the UE 150.

Determining that a conditional handover is to be configured at the UE 150 can be performed in any suitable way using any suitable method.

In examples, determining that a conditional handover is to be configured at the UE 150 comprises transmitting and/or receiving one or more signals and/or messages.

In examples, determining that a conditional handover is to be configured at the UE 150 comprises receiving measurement information from the UE 150.

As FIG. 2 illustrates one or more actions of transmission, for example, of one or more signals, FIG. 2 also illustrates the corresponding transmitting/causing transmission feature(s)/action(s).

Similarly, for any transmitting/causing transmission feature(s)/action(s), FIG. 2 also illustrates the corresponding receiving/causing receiving feature(s)/action(s).

For example, from the point of view of the source MN 152, block 204 can be considered to illustrate receiving measurement information from the UE 150.

Similarly, from the point of view of the UE 150, block 204 can be considered to illustrate transmitting measurement information to the source MN 152.

In examples, determining that a conditional handover is to be configured at the UE 150 comprises receiving at least one Measurement Report message.

For example, at least one Measurement Report message can be transmitted from the UE 150 to the source MN 152.

At block 206, method 200 comprises determining configuration information 142 comprising information 144 to allow the UE 150 to conditionally handover the connection from the source MN primary cell 140 towards a target primary cell 148 and further information 146 to allow the UE 150 to access a plurality of target primary secondary cells 151a, 151b, associated with the target primary cell 148 and at least one associated access condition.

A target primary secondary cell 151 can be considered a target primary cell of a secondary cell group.

A target primary secondary cell 151 can be considered a target special cell of a secondary cell group.

A target primary secondary cell 151 can be considered to be associated with a target primary cell 148 because the target primary secondary cell 151 is linked to the target primary cell 148 to potentially provide dual connectivity with the target primary cell 148.

Determining configuration 142 can be performed in any suitable way using any suitable method.

In examples, determining configuration information 142 comprises transmitting and/or receiving one or more signals and/or messages, for example with a target MN 154. This is illustrated in the example of FIG. 2 by the double headed arrow 157 between block 206 and the target MN 154.

For example, the source MN 152 can transmit a Handover Request message to the target MN 154.

In examples, determining configuration information 142 comprises receiving at least part of the configuration information 142 from the target MN 154.

For example, the source MN 152 can receive at least part of the configuration information 142 from the target MN 154 as part of a Handover Request Acknowledge message.

Accordingly, in examples, the target MN 154 can determine and/or generate at least part of the configuration information 142. In examples, the target MN 154 can determine at least part of the information 144 and further information 146.

In examples, determining, by the target MN 154, at least part of the configuration information 142 comprises transmitting and/or receiving one or more signals and/or messages, for example with a plurality of target SNs 156a, 156b. This is illustrated in the example of FIG. 2 by the double headed arrows 161, 163 between the target MN 154 and target SN 156a, and between target MN 154 and target SN 156b.

For example, the target MN 154 can transmit a SN Addition Request message to a plurality of target SNs 156a, 156b.

For example, the target SNs 156a, 156b can transmit a SN Addition Request Acknowledgement message to the target MN 154.

In examples, configuration information 142 can be considered any suitable information to configure a UE 150.

In examples, the configuration information 142 can comprise any suitable information and any suitable further information 146.

For example, the information 144 can comprise any suitable information 144 to allow the UE 150 to conditionally handover the connection from the source primary cell 140 towards a target primary cell 151a, 151b.

In examples, the information 144 comprises one or more handover execution conditions for the target primary cell 140. The handover execution condition or conditions can be pre-configured by the network 100.

The handover execution condition can comprise any suitable condition.

In some examples, the handover execution condition can be a radio signal condition. For example, the handover execution condition can comprise a received radio signal power condition and/or a received radio signal quality condition.

In examples, the handover execution condition can be based on and/or related to reference signal received power (RSRP) and/or reference signal received quality (RSRQ).

In examples, the handover execution condition can comprise, for example, A3, A4 or A5 event.

In some examples, the handover execution condition can be a Conditional Handover (CHO) condition.

In some examples the information 144 comprises Conditional handover (CHO) configuration information.

In examples, the further information 144 can comprise any suitable information to allow the UE 150 to access at least one of a plurality of target primary secondary cells 151a, 151b, associated with the target primary cell 148.

In some examples, the associated access condition(s) are associated with the further information.

For example, information to allow the UE 150 to access a first target primary secondary cell 156a can have one or more associated access conditions and information to allow the UE 150 to access a second target primary secondary cell 156b can have one or more associated access conditions.

In some examples, the further information 144 comprises at least one access condition associated with information to allow the UE 150 to access each target primary secondary cell 156.

An associated access condition can comprise any suitable condition.

In some examples, the access condition can be a radio signal condition. For example, the access condition can comprise a received radio signal power condition and/or a received radio signal quality condition.

In examples, the access condition can be based on and/or related to reference signal received power (RSRP) and/or reference signal received quality (RSRQ).

In examples, the access condition can comprise, for example, A3, A4 or A5 event.

In examples, an access condition can be considered to be associated with information to allow the UE 150 to access a target primary secondary cell 151 because the access condition relates to the target primary secondary cell 151. For example, an access condition can be considered to be associated with information to allow the UE 150 to access a target primary secondary cell 151 because the access condition relates to a radio signal condition of the target primary secondary cell 151. In examples, the associated access conditions can be considered access conditions for the target primary secondary cell(s) 151a, 151b.

In some examples, the further information 146 comprises Dual Connectivity (DC) configuration information. Accordingly, in examples, the associated condition(s) can be considered addition/change condition(s).

In some examples, the associated condition(s) can comprise or be Conditional PSCell Addition and Change (CPAC) conditions.

In some examples, the further information 146 comprises a plurality of configurations configured to allow the UE 150 to conditionally access a plurality of target primary secondary cells 151a, 151b, wherein the plurality of configurations have associated release and add indications.

The plurality of configurations can comprise any suitable configurations. For example, the plurality of configurations can comprise any suitable configurations to allow the UE 150 to conditionally access a plurality of target primary secondary cells 151a, 151b.

In examples, each configuration can relate to a target primary secondary cell 151 and has one or more associated access conditions.

In some examples, the plurality of configurations configured to allow the UE 150 to conditionally access the plurality of target primary secondary cells 151a, 151b, comprise full configurations.

A full configuration can be considered a configuration that is independent of any other configurations.

A full configuration can be considered a configuration that a UE 150 can apply directly without considering and/or using and/or applying any other configuration or configurations.

A full configuration can be considered a configuration that defines all the parameters that are needed by the UE 150 to access a target primary secondary cell 151.

In examples, a full configuration can be considered a complete configuration and/or a whole configuration.

In some examples, the plurality of configurations configured to allow the UE 150 to conditionally access the plurality of target primary secondary cells 151a, 151b, comprise delta configurations configured to be applied on a reference primary secondary cell configuration 160 to obtain a full configuration.

A delta configuration can be considered a configuration that is applied on top of another configuration to achieve a new configuration.

A delta configuration can be considered a configuration that is dependent on at least one other configuration.

A delta configuration can be considered a configuration that a UE 150 cannot apply without considering and/or using and/or applying at least one other configuration.

A delta configuration can be considered a configuration that defines only the parameters that need to be modified, added, or released compared to a base/reference configuration to access a target primary secondary cell 151.

In examples, a delta configuration can be considered an incomplete and/or partial configuration.

In examples, accessing a target primary secondary cell 151, or any other suitable cell, comprises performing an access procedure with the cell, for example a random access procedure.

In examples, accessing a target primary secondary cell 151, or any other suitable cell, comprises establishing a connection with and/or via the cell.

At block 208, method 200 comprises transmitting the configuration information 142 to the UE 150.

Accordingly, from the point of view of the source MN 152, block 208 comprises transmitting, to the UE 150, configuration information 142 comprising information 144 to allow the UE 150 to conditionally handover the connection from the source primary cell 140 towards a target primary cell 148 and further information 146 to allow the UE 150 to access a plurality of target primary secondary cells 151a, 151b, associated with the target primary cell 148 and at least one associated access condition.

Accordingly, from the point of view of the UE 150, block 208 comprises receiving configuration information 142 comprising information 144 to allow the UE 150 to conditionally handover the connection from the primary cell 140 towards a target primary cell 148 and further information 146 to allow the UE 150 to access of a plurality of target primary secondary cells 151a, 151b, associated with the target primary cell 148 and at least one associated access condition.

Transmitting the configuration information 142 can be performed in any suitable way using any suitable method.

In examples, transmitting the configuration information 142 comprises transmitting one or more signals and/or messages.

In some examples, the configuration information 142 can be transmitted as part of a RRC Reconfiguration message.

As described above, in some examples, the plurality of configurations configured to allow the UE 150 to conditionally access the plurality of target primary secondary cells 151a, 151b, comprise delta configurations.

Furthermore, as described above, in some examples the UE 150 is connected to a source SN 153.

In some such examples, method 200 comprises block 210.

At block 210, method 200 comprises transmitting, to the UE 150, an indication 162 that the current primary secondary cell configuration 164 should be maintained as a reference primary secondary cell configuration 160 after sending an access request 158 towards a first target primary secondary cell 151a.

Consequently, FIG. 2 illustrates a method 200 comprising:
establishing a connection towards a user equipment, UE 150, via a source primary cell 140;
determining that conditional handover is to be configured at the UE 150;
transmitting, to the UE 150, configuration information 142 comprising information 144 to allow the UE 150 to conditionally handover the connection from the source primary cell 140 towards a target primary cell 148 and further information 146 to allow the UE 150 to access a plurality of target primary secondary cells 151a, 151b, associated with the target primary cell 148 and at least one associated access condition; and
transmitting, to the UE 150, an indication 162 that the current primary secondary cell configuration 164 should be maintained as a reference primary secondary cell configuration 160 after sending an access request 158 towards a first target primary secondary cell 151.

Transmitting the indication 162 can be performed in any suitable way using any suitable method.

In examples, transmitting the configuration information 162 comprises transmitting one or more signals and/or messages.

In some examples, the indication 162 can be transmitted with the configuration information 142 at block 208. Accordingly, in some examples, blocks 208 and 210 can be combined.

For example, the indication 162 can be transmitted as part of a RRC Reconfiguration message.

The indication 162 can have any suitable form. For example, the indication 162 can have any suitable form to indicate, to the UE 150, that the current primary secondary cell configuration 164 should be maintained as a reference primary secondary cell configuration 160 after sending an access request 158 towards a first target primary secondary cell 151(1). The indication 162 can comprise any suitable flag or indicator and so on.

In some examples, the indication 162 comprises the current primary secondary cell configuration 164.

A current primary secondary cell configuration can be considered a primary secondary cell configuration that is currently configured at and/or used by the UE 150.

A current primary secondary cell configuration can be considered a most recent primary secondary cell configuration generated by a source SN 153.

From the point of view of the UE 150, block 210 comprises receiving an indication 162 that the current primary secondary cell configuration 164 should be maintained as a reference primary secondary cell configuration 160 after sending an access request 158 towards the first target primary secondary cell 151a.

As described above, in examples the indication 162 comprises the current primary secondary cell configuration.

At block 212, method 200 comprises, determining that a handover execution condition for the target primary cell 148 is satisfied.

Determining that a handover execution condition for the target primary cell 148 is satisfied can be performed in any suitable way using any suitable method.

In examples, determining that a handover execution condition for the target primary cell 148 is satisfied comprises determining and/or making one or more measurements.

The one or more measurements can comprise one or more radio signal measurements. For example, received radio signal quality and/or received radio signal strength and so on.

In some examples, determining that the handover execution condition for the target primary cell 148 is satisfied comprises monitoring the target primary cell 148.

At block 214, method 200 comprises establishing a connection towards the target primary cell 148. Establishing a connection can be as described in relation to block 202.

In examples, block 214 can comprise establishing a connection towards the target primary cell 148 based, at least in part, on the received information 144 of the configuration information 142.

Additionally, or alternatively, in examples block 214 can comprise establishing a connection towards the target primary cell 148, based, at least in part, on the determination that the handover execution condition for the target primary cell 148 is satisfied.

At block 216, method 200 comprises sending, based at least in part on at least a portion of the further information 146, an access request 158 towards a first target primary secondary cell 151a of the plurality of target primary secondary cells 151a, 151b.

Any suitable access request 158 having any suitable form can be used. For example, any suitable access request 158 from any suitable access procedure can be used.

In some examples, sending an access request 158 towards the first target primary secondary cell 151a comprises sending a random access request towards the first target primary secondary cell 151a.

In examples, block 216 can comprise at least initiating an access procedure with the first target primary secondary cell 151a. Any suitable access procedure can be used, for example a random access channel (RACH) procedure can be used.

Accordingly, in examples, the access request 158 can form part of a RACH procedure.

In some examples, block 216 comprises sending, based at least in part on a configuration of the plurality of configurations configured to allow the UE 150 to conditionally access a plurality of target primary secondary cells, an access request 158 towards a first target primary secondary cell 151a of the plurality of target primary secondary cells 151a, 151b.

In some examples, block 216 comprises applying a configuration of the plurality of configurations.

In examples, the UE 150 applying a configuration comprises the UE 150 applying the configuration to the UE's radio network protocol to enable the UE 150 to access and/or connect to the cell.

In some examples, applying the configuration comprises decoding the configuration.

At block 218, method 200 comprises maintaining, after sending the access request 158 towards the first target primary secondary cell 151a, at least part of the further information 146 to allow the UE 150 to access at least one target primary secondary cell 151b different to the first target primary secondary cell 151a.

Consequently, FIG. 2 illustrates a method 200 comprising:
establishing a connection towards a primary cell 140 of a master node 152;
receiving configuration information 142 comprising information 144 to allow the UE 150 to conditionally handover the connection from the primary cell 140 towards a target primary cell 148 and further information 146 to allow the UE 150 to a plurality of target primary secondary cells 151a, 151b, associated with the target primary cell 148 and at least one associated access condition;
determining that a handover execution condition for the target primary cell is satisfied;
establishing a connection towards the target primary cell 148;
sending, based at least in part on at least a portion of the further information 146, an access request 158 towards a first target primary secondary cell 151a of the plurality of target primary secondary cells 151a, 151b; and
maintaining, after sending the access request 158 towards the first target primary secondary cell 151a, at least part of the further information 146 to allow the UE 150 to access at least one target primary secondary cell 151b different to the first target primary secondary cell 151a.

Maintaining a least part of the further information 146 can be performed in any suitable way using any suitable method.

For example, maintaining at least part of the further information 146 can comprise maintaining at least part of the further information 146 in at least one data structure. For example, maintaining at least part of the further information 146 can comprise not resetting and/or not deleting and/or not removing the at least part of the further information 146.

In examples, block 218 comprises maintaining at least one configuration of the plurality of configurations that has not been used/applied by the UE 150.

In some examples, block 218 comprises maintaining at least one full configuration.

In some examples, block 218 comprises maintaining at least one delta configuration and associated reference primary secondary cell configuration. For example, block 218 can comprise maintaining at least one delta configuration and the current primary secondary cell configuration 164.

At block 220, method 200 comprises determining that access towards the first target primary secondary cell 151a has failed and sending, based at least in part on at least a portion of the further information 146 that was maintained after sending the access request 158 towards the first target primary secondary cell 151a, an access request 158 towards a second, different target primary secondary cell 151b.

Determining that access towards the first target primary secondary cell 151a has failed can be performed in any suitable way using any suitable method.

In examples, determining that access towards the first target primary secondary cell 151a has failed comprises determining that establishing a connection towards the first target primary secondary cell 151a has failed.

Sending an access request 158 at block 220 can be as described in relation to block 216, but towards the second, different target primary cell 151b.

In examples, block 220 comprises using and/or applying at least one configuration of the plurality of configurations that has not been used/applied by the UE 150.

In some examples, block 220 comprises using and/or applying at least one full configuration.

In some examples, block 220 comprises using and/or applying at least one delta configuration and associated reference primary secondary cell configuration. For example, block 220 can comprise using and/or applying at least one delta configuration on top of the current primary secondary cell configuration 164.

In some examples, method 200 comprises when the handover execution for the target primary cell 148 is satisfied, determining that none of the associated access conditions of the plurality of target primary secondary cells 151a, 151b, are satisfied and selecting a target primary secondary cell 151 to be used as the first target primary secondary cell 151a.

Determining that none of the associated access conditions are satisfied can be performed in any suitable way using any suitable method.

In examples, determining that none of the associated conditions are satisfied comprises determining and/or making one or more measurements.

The one or more measurements can comprise one or more radio signal measurements. For example, received radio signal quality and/or received radio signal strength and so on.

In some examples, determining that none of the associated conditions are satisfied comprises monitoring the target primary secondary cells 151.

Selecting a target primary secondary cell 151 to be used as the first target primary secondary cell 151a can be performed in any suitable way, using any suitable method.

In examples, selecting a target primary secondary cell 151 comprises randomly selecting a target primary secondary cell 151.

In examples, selecting a target primary secondary cell 151 comprises selecting a target primary secondary cell 151 based, at least in part, on a predetermined order for the plurality of target primary secondary cells 151a, 151b.

In examples, selecting a target primary secondary cell 151 comprises selecting a target primary secondary cell 151 based, at least in part, on one or more radio signal measurement. For example, the target primary secondary cell 151 having the best radio signal conditions can be selected.

Examples of the disclosure are advantageous and provide technical benefits.

For example, examples of the disclosure allow a UE to efficiently recover from target PSCell failure.

FIG. 3 illustrates an example of a method 300.

FIG. 3 is similar to the example of FIG. 2 and similarly shows the plurality of apparatus transmitting and/or receiving one or more signals and/or one or more messages across and/or via and/or using a network.

In examples, the plurality of apparatuses in FIG. 3 form at least a portion of a network 100 as described in relation to FIG. 1.

In examples, FIG. 3 can be considered to illustrate a plurality of methods. For example, FIG. 3 illustrates one or more actions at a plurality of actors/entities. In examples, FIG. 3 can be considered to illustrate a plurality of methods performed by the individual actors/entities.

In the illustrated example, a terminal node 110, and four access nodes 120 transmit and/or receive one or more signals and/or one or more messages. In the example of FIG. 3 the terminal node 110 is a UE 150 and the four access nodes 120 are a source MN 152, a target MN 154, and two target SNs 151a and 151b.

In examples (not illustrated in FIG. 3) the UE 150 can also be connected to a source SN.

In examples, communications and/or transmissions between elements illustrated in FIG. 3 can proceed via any number of intervening elements, including no intervening elements.

Although one UE 150 is illustrated in the example of FIG. 3, in examples any suitable number of UEs 150 can be included.

Similarly, in examples, any suitable number of network nodes can be included.

In examples, method 300 and/or one or more parts of method 300 can be considered a method of enhancing conditional handover.

In examples, method 300 and/or one or more parts of method 300 can be considered a method of enhancing conditional handover with dual connectivity.

In examples, method 300 and/or one or more parts of method 300 can be considered a method of enhancing conditional handover with multiple PSCell preparations.

In the illustrated example, the location of the blocks indicates the entity performing the action(s). For example, block 304 is performed at/by the source MN 152.

At block 302, method 300 comprises from the point of view of the source MN 152, establishing a connection towards a user equipment, UE 150, via a source primary cell 140 (PCell of source MN 152).

In some examples, the source MN 152 can be considered a source MN 152 when the connection towards the UE 150 has been established.

From the point of view of the UE 150, block 302 comprises establishing a connection towards a primary cell of a master node 152.

This is illustrated in the example of FIG. 3, by the double headed arrow between the UE 150 and source MN 152.

Accordingly, it can be considered that block 203 comprises establishing a connection between a UE 150 and a source MN 152.

In examples, block 302 can be as described in relation to block 302 of the example of FIG. 2. Accordingly, establishing a connection at block 302 can be as described in relation to block 202.

At block 304, method 300 comprises determining that a conditional handover is to be configured at the UE 150.

In examples, block 304 can be as described in relation to block 204 of the example of FIG. 2.

At block 306, method 300 comprises, from the point of view of the target MN 154, receiving a handover request. Accordingly, from the point of view of the source MN 152, block 206 illustrates transmitting a handover request.

The handover request can have any suitable form and can be transmitted in any suitable way using any suitable method.

In examples, receiving the handover request comprises receiving one or more signals and/or messages.

Receiving the handover request can comprise receiving a Handover Request message.

The handover request can comprise any suitable information. In examples, the handover request comprises information to request the target MN 154 to prepare for handover of a connection with a UE 150.

In some examples, the handover request indicates that a conditional handover is to be configured.

At block 308, method 300 comprises requesting a target secondary node 156 to determine a reference primary secondary cell configuration 160.

In examples, requesting a target secondary node 156 to determine a reference primary secondary cell configuration 160 can be performed in any suitable way using any suitable method.

In some examples, requesting a target secondary node 156 to determine a reference primary secondary cell configuration 160 comprises transmitting one or more signals and/or messages.

For example, requesting a target secondary node 156 to determine a reference primary secondary cell configuration 160 can comprise transmitting a SN Addition Request message to the target secondary node 156.

Requesting a target secondary node 156 to determine a reference primary secondary cell configuration 160 can comprise transmitting an indication to the target secondary node 156 to determine a reference primary secondary cell configuration 160.

The indication can have any suitable form. For example, the indication can have any suitable form to indicate, to the target SN 156, that the target SN 156 should determine a reference primary secondary cell configuration 160. The indication 162 can comprise any suitable flag or indicator and so on.

In some examples, the indication comprises a ‘null’ indication for a base target SCG Config in a SN Addition Request message.

The target MN 154 can request any suitable target SN 156 to determine a reference primary secondary cell configuration 160. In the example of FIG. 3 the target MN requests target SN 156a to determine a reference primary secondary cell configuration 160.

The target SN 156a determines the reference primary secondary cell configuration 160.

Determining the reference primary secondary cell configuration 160 can be performed in any suitable way using any suitable method.

For example, if the target MN 154 already has a reference primary secondary cell configuration, the target MN 154 can share this reference primary secondary cell configuration with the target MN 154 and the target SN 156 can consider the reference primary cell configuration from the target MN 154 when determining the reference primary secondary cell configuration.

In examples, the target MN 154 does not provide a reference primary secondary cell configuration to the target SN 156 and the target SN 156 determines/generates the reference primary secondary cell configuration 160.

In some examples, the target SN 156 considers the source primary secondary cell configuration and/or the target primary cell configuration when determining the reference primary secondary cell configuration 150.

At block 310, method 300 comprises, from the point of view of the target MN 154, receiving the reference primary secondary cell configuration 160 from the target secondary node 156.

Receiving the reference primary secondary cell configuration 160 from the target secondary node 156 can be performed in any suitable way using any suitable method.

In examples, block 310 comprises receiving one or more signals and/or messages.

In some examples, receiving the reference primary secondary cell configuration 160 comprises receiving the reference primary secondary cell configuration 160 as part of an SN Addition Request Acknowledgement message.

The reference primary secondary cell configuration can be any suitable reference configuration.

For example, the reference primary secondary cell configuration can be the current primary secondary cell configuration.

For example, the reference primary secondary cell configuration can be based, at least in part, on the current primary secondary cell configuration.

For example, the reference primary secondary cell configuration can be independent of the current primary secondary cell configuration.

In some examples, method 300 comprises receiving a delta configuration, determined relative to the determined reference primary secondary cell configuration 160, from the target secondary node 156.

The delta configuration can be received with or separate from the determined reference primary secondary cell configuration 160.

For example, the delta configuration can be received as part of the SN Addition Request Acknowledgement.

At block 312, method 300 comprises requesting at least one different target secondary node 156b to determine a delta configuration, relative to the reference primary secondary cell configuration 160, configured to allow a UE 150 to access at least one target primary secondary cell 151 associated with the at least one different target secondary node 156b.

In examples, requesting at least one different target secondary node 156b to determine a delta configuration, relative to the reference primary secondary cell configuration 160, to allow a UE 150 to access at least one target primary secondary call 151 associated with the at least one different target secondary node 156b can be performed in any suitable way using any suitable method.

In some examples, requesting at least one different target secondary node 156b to determine a delta configuration, relative to the reference primary secondary cell configuration 160 comprises transmitting one or more signals and/or messages.

For example, requesting at least one different target secondary node 156b to determine a delta configuration, relative to the reference primary secondary cell configuration 160 can comprise transmitting a SN Addition Request message to the target secondary node 156.

Requesting at least one different target secondary node 156b to determine a delta configuration, relative to the reference primary secondary cell configuration 160 can comprise transmitting an indication to the at least one different target secondary node 156b to determine a delta configuration, relative to the reference primary secondary cell configuration 160.

The indication can have any suitable form. For example, the indication can have any suitable form to indicate, to the at least one different target SN 156b, that the at least one different target SN 156b should determine a delta configuration, relative to the reference primary secondary cell configuration 160, configured to allow a UE 150 to access at least one target primary secondary cell 151 associated with the at least one different target secondary node 156b.

In some examples, the indication comprises the reference primary secondary cell configuration 160 in a SN Addition Request message.

In examples, the target MN 154 transmits the reference primary secondary cell configuration 160 to the at least one different target SN 156b, whether as the indication or not.

The at least one different target SN 156b determines the delta configuration, relative to the reference primary secondary cell configuration 160, and at block 314, method 300 comprises, from the point of view of the target MN 154, receiving at least one requested delta configuration from the at least one different target secondary node 156b.

Consequently, FIG. 3 illustrates a method 300 comprising:
requesting a target secondary node 156 to determine a reference primary secondary cell configuration 160;
receiving the reference primary secondary cell configuration 160 from the target secondary node;
requesting at least one different target secondary node 156 to determine a delta configuration, relative to the reference primary secondary cell configuration 160, configured to allow a UE 150 to access at least one target primary secondary cell 151 associated with the at least one different target secondary node 156; and
receiving at least one requested delta configuration from the at least one different target secondary node 156.

In examples, block 314 comprises receiving a requested delta configuration from a plurality of different target secondary nodes 156.

Receiving the at least one requested delta configuration from the at least one different target secondary node 156 can be performed in any suitable way using any suitable method.

In examples, block 314 comprises receiving one or more signals and/or messages.

In some examples, receiving the at least one requested delta configuration comprises receiving the reference primary secondary cell configuration 160 as part of an SN Addition Request Acknowledgement message.

At block 316, method 300 comprises, from the point of view of the target MN 154, transmitting the received at least one requested delta configuration and the reference primary secondary cell configuration 160 to a source master node 154.

In some examples, block 316 comprises transmitting the delta configuration received from the target SN 156 that determined the reference primary secondary cell configuration 160.

Transmitting the received at least one requested delta configuration and the reference primary secondary cell configuration 160 can be performed in any suitable way using any suitable method.

In examples, transmitting the received at least one requested delta configuration and the reference primary secondary cell configuration 160 comprises transmitting one or more signals and/or messages.

In some examples, the received at least one requested delta configuration and the reference primary secondary cell configuration 160 can be transmitted as part of a Handover Request Acknowledge message.

At block 317, method 300 comprises determining configuration information 142 comprising information 144 to allow a UE 150 to conditionally handover the connection from the primary cell 140 towards a target primary cell 148 and further information 146 to allow the UE 150 to access a plurality of target secondary cells 151a, 151b, associated with the target primary cell 148 and at least one associated access condition, wherein the further information 146 comprises a plurality of delta configurations for application to a reference primary secondary cell configuration 160, and the reference primary secondary cell configuration 160.

In examples, block 317 can be as described in relation to block 206 of the example of FIG. 2.

Accordingly, in some examples, block 317 comprises receiving the information from the target MN 154 at block 316.

Accordingly, in some examples, the reference primary secondary cell configuration 160 has been determined by a target secondary node 156.

At block 318, method 300 comprises transmitting the configuration information 142 to the UE 150.

Consequently, FIG. 3 illustrates a method 300 comprising:
establishing a connection towards a user equipment, UE 150, via a source primary cell 140;
determining configuration information 142 comprising information 144 to allow the UE 150 to conditionally handover the connection from the primary cell 140 towards a target primary cell 148 and further information 146 to allow the UE 150 to access a plurality of target secondary cells 151a, 151b, associated with the target primary cell 148 and at least one associated access condition, wherein the further information 146 comprises a plurality of delta configurations for application to a reference primary secondary cell configuration 160, and the reference primary secondary cell configuration 160; and
transmitting the configuration information 142 to the UE 150.

Transmitting the configuration information 142 can be performed in any suitable way using any suitable method.

In examples, transmitting the configuration information 142 comprises transmitting one or more signals and/or messages.

In some examples, the configuration information 142 can be transmitted as part of a RRC Reconfiguration message.

From the point of view of the UE 150, block 318 comprises receiving configuration information 142 comprising information 144 to allow the UE 150 to conditionally handover the connection from the primary cell 140 towards a target primary cell 148 and further information 146 to allow the UE 150 to access a plurality of target secondary cells 151a, 151b, associated with the target primary cell 148 and at least one associated access condition, wherein the further information 146 comprises a plurality of delta configurations for application to a reference primary secondary cell configuration 160, and the reference primary secondary cell configuration 160.

Accordingly, in examples, method 300 comprises receiving, at and/or by the UE 150, the reference primary secondary cell configuration 160, wherein the reference primary secondary cell configuration 160 has been determined by a target secondary node 160.

At block 320, method 300 comprises determining that a handover execution condition for the target primary cell 140 is satisfied and that none of the conditions to access the plurality of target primary secondary cells 151a, 151b, are satisfied.

Determining that a handover execution condition for the target primary cell 140 is satisfied and that none of the conditions to access the plurality of target primary secondary cells 151a, 151b, are satisfied can be performed in any suitable way using any suitable method.

In examples, block 320 comprises determining and/or making one or more measurements.

The one or more measurements can comprise one or more radio signal measurements. For example, received radio signal quality and/or received radio signal strength and so on.

In some examples, block 320 comprises monitoring the target primary cell 148 and the plurality of target primary secondary cells 151a, 151b.

At block 322, method 300 comprises establishing a connection towards the target primary cell 148. Establishing a connection can be as described in relation to block 202.

In examples, block 322 can comprise establishing a connection towards the target primary cell 148 based, at least in part, on the received information 144 of the configuration information 142.

Additionally, or alternatively, in examples block 214 can comprise establishing a connection towards the target primary cell 148, based, at least in part, on the determination that the handover execution condition for the target primary cell 148 is satisfied.

At block 324, method 300 comprises applying the reference primary secondary cell configuration 160.

Accordingly, in the example of FIG. 3, after block 320 the UE 150 applies the reference primary secondary cell configuration 160, preparing the UE 150 for application of a delta configuration.

Consequently, FIG. 3 illustrates a method 300 comprising:
establishing a connection towards a primary cell 140 of a master node 142;
receiving configuration information 142 comprising information 144 to allow the UE 150 to conditionally handover the connection from the primary cell 140 towards a target primary cell 148 and further information 146 to allow the UE 150 to access a plurality of target secondary cells 151a, 151b, associated with the target primary cell 148 and at least one associated access condition, wherein the further information 146 comprises a plurality of delta configurations for application to a reference primary secondary cell configuration 160, and the reference primary secondary cell configuration 160.
establishing a connection towards the target primary cell 140; and
applying the reference primary secondary cell configuration 160.

At block 326, method 300 comprises determining, at a later time, that a condition to access a first target primary secondary cell 151b of the plurality of target primary secondary cells 151a, 151b, is satisfied.

In examples, block 326 comprises determining and/or making one or more measurements.

The one or more measurements can comprise one or more radio signal measurements. For example, received radio signal quality and/or received radio signal strength and so on.

In some examples, block 326 comprises monitoring the plurality of target primary secondary cells 151a, 151b.

At block 328, method 300 comprises applying a first delta configuration of the plurality of delta configurations to the reference primary secondary cell configuration to access the first target primary secondary cell 151b of the plurality of target primary secondary cell 151a, 151b.

Accordingly, in some examples, method 300 comprises, if it is determined at a later time that a condition to access a first target primary secondary cell 151b of the plurality of target primary secondary cells 151a, 151b, is satisfied, applying a first delta configuration of the plurality of delta configurations to the reference primary secondary cell configuration 160 to access the first target primary secondary cell 151b of the plurality of target primary secondary cells 151.

Examples of the disclosure are advantageous and provide one or more technical benefits.

For example, examples of the disclosure provide for a reference primary secondary cell configuration 160 to be determined by a target SN.

For example, examples of the disclosure provide for a UE to be prepared for application of a delta configuration to access a target primary secondary cell when it is determined that a CHO condition has been met.

FIG. 4 illustrates an example of a method 400.

In examples, method 400 can be performed by any suitable apparatus comprising any suitable means for performing method 400. For example, an apparatus as described in relation to FIGS. 12A and/or 12B.

In examples, method 400 can be performed by a UE 150, such as a UE 105 of FIG. 1 and/or FIG. 2.

At block 402, method 400 comprises establishing a connection towards a primary cell 140 of a master node 152.

At block 404, method 400 comprises receiving configuration information 142 comprising information 144 to allow the UE 150 to conditionally handover the connection from the primary cell 140 towards a target primary cell 148 and further information 146 to allow the UE 150 to access a plurality of target primary secondary cells 151a, 151b, associated with the target primary cell 148 and at least one associated access condition.

At block 406, method 400 comprises determining that a handover execution condition for the target primary cell 148 is satisfied.

At block 408, method 400 comprises establishing a connection towards the target primary cell 148.

At block 410, method 400 comprises sending, based at least in part on at least a portion of the further information 146, an access request 158 towards a first target primary secondary cell 151a of the plurality of target primary secondary cells 151a, 151b; and
maintaining, after sending the access request 158 towards the first target primary secondary cell 151a, at least part of the further information 146 to allow the UE 150 to access at least one target primary secondary cell 151b different to the first target primary secondary cell 151a.

Consequently, FIG. 4 illustrates a method 400 comprising:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition;

Determining that a handover execution condition for the target primary cell is satisfied;
establishing a connection towards the target primary cell;
sending, based at least in part on at least a portion of the further information, an access request towards a first target primary secondary cell of the plurality of target primary secondary cells; and
maintaining, after sending the access request towards the first target primary secondary cell, at least part of the further information to allow the UE to access at least one target primary secondary cell different to the first target primary secondary cell.

FIG. 5 illustrates an example of a method 500.

In examples, method 500 can be performed by any suitable apparatus comprising any suitable means for performing method 500. For example, an apparatus as described in relation to FIGS. 12A and/or 12B.

In examples, method 500 can be performed by a source MN 152, such as a source MN 152 of FIG. 2.

At block 502, method 500 comprises establishing a connection towards a user equipment, UE 150, via a source primary cell 140.

At block 504, method 500 comprises determining that conditional handover is to be configured at the UE 150.

At block 506, method 500 comprises transmitting, to the UE 150, configuration information 142 comprising information 144 to allow the UE 150 to conditionally handover the connection from the source primary cell 140 towards a target primary cell 148 and further information 146 to allow the UE 150 to access a plurality of target primary secondary cells 151a, 151b, associated with the target primary cell 148 and at least one associated access condition.

At block 506, method 500 comprises transmitting, to the UE 150, an indication 162 that the current primary secondary cell configuration 164 should be maintained as a reference primary secondary cell configuration 160 after sending an access request 158 towards a first target primary secondary cell 151b.

Consequently, FIG. 5 illustrates a method 500 comprising:
establishing a connection towards a user equipment, UE, via a source primary cell;
determining that conditional handover is to be configured at the UE;
transmitting, to the UE, configuration information comprising information to allow the UE to conditionally handover the connection from the source primary cell towards a target primary cell and further information to allow the UE to a plurality of target primary secondary cells associated with the target primary cell and at least one associated access condition; and
transmitting, to the UE, an indication that the current primary secondary cell configuration should be maintained as a reference primary secondary cell configuration after sending an access request towards a first target primary secondary cell.

FIG. 6 illustrates an example of a method 600.

In examples, method 600 can be performed by any suitable apparatus comprising any suitable means for performing method 500. For example, an apparatus as described in relation to FIGS. 12A and/or 12B.

In examples, method 600 can be performed by a UE 150, such as a UE 150 of FIG. 1 and/or FIG. 2.

At block 602, method 600 comprises establishing a connection towards a primary cell 140 of a master node 152.

At block 604, method 600 comprises receiving configuration information 142 comprising information 144 to allow the UE 150 to conditionally handover the connection from the primary cell 140 towards a target primary cell 148 and further information 146 to allow the UE 150 to access a plurality of target primary secondary cells 151a, 151b associated with the target primary cell 148 and at least one associated access condition, wherein the further information 146 comprises a plurality of delta configurations for application to a reference primary secondary cell configuration 160.

At block 606, method 600 comprises determining that a handover execution condition for the target primary cell 148 is satisfied and that none of the conditions to access the plurality of target primary secondary cells 151a, 151b are satisfied.

At block 608, method 600 comprises establishing a connection towards the target primary cell 148.

At block 610, method 600 comprises applying the reference primary secondary cell configuration 160.

Consequently, FIG. 6 illustrates a method 600 comprising:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determining that a handover execution condition for the target primary cell is satisfied and that none of the conditions to access the plurality of target primary secondary cells are satisfied;
establishing a connection towards the target primary cell; and
applying the reference primary secondary cell configuration.

FIG. 7 illustrates an example of a method 700.

In examples, method 700 can be performed by any suitable apparatus comprising any suitable means for performing method 500. For example, an apparatus as described in relation to FIGS. 12A and/or 12B.

In examples, method 700 can be performed by a target MN 154, such as a target MN 154 of FIG. 2.

At block 702, method 700 comprises requesting a target secondary node 156 to determine a reference primary secondary cell configuration 160.

At block 704, method 700 comprises receiving the reference primary secondary cell configuration 160 from the target secondary node 156.

At block 706, method 700 comprises requesting at least one different target secondary node 156b to determine a delta configuration, relative to the reference primary secondary cell configuration 160, configured to allow a UE 150 to access at least one target primary secondary cell 151b associated with the at least one different target secondary node 151b.

At block 708, method 700 comprises receiving at least one requested delta configuration from the at least one different target secondary node 156b.

Consequently, FIG. 7 illustrates a method 700 comprising:
requesting a target secondary node to determine a reference primary secondary cell configuration;
receiving the reference primary secondary cell configuration from the target secondary node; and
requesting at least one different target secondary node to determine a delta configuration, relative to the reference primary secondary cell configuration, configured to allow a UE to access at least one target primary secondary cell associated with the at least one different target secondary node; and
receiving at least one requested delta configuration from the at least one different target secondary node.

FIG. 8 illustrates an example of a method 800.

In examples, method 800 can be performed by any suitable apparatus comprising any suitable means for performing method 400. For example, an apparatus as described in relation to FIGS. 12A and/or 12B.

In examples, method 800 can be performed by a source MN 152, such as a source MN 152 of FIG. 2.

At block 802, method 800 comprises establishing a connection towards a user equipment, UE 150, via a source primary cell 140.

At block 804, method 800 comprises determining configuration information 142 comprising information 144 to allow the UE 150 to conditionally handover the connection from the primary cell 140 towards a target primary cell 148 and further information 146 to allow the UE 150 to access a plurality of target primary secondary cells 151a, 151b, associated with the target primary cell 148 and at least one associated access condition, wherein the further information 146 comprises a plurality of delta configurations for application to a reference primary secondary cell configuration 160, and the reference primary secondary cell configuration 160.

At block 806, method 800 comprises transmitting the configuration information to the UE.

Consequently, FIG. 8 illustrates a method 800 comprising:
establishing a connection towards a user equipment, UE, via a source primary cell;
determining configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
transmitting the configuration information to the UE.

FIG. 9 illustrates an example of a method 900.

Some examples relate to third generation Partnership Project (3GPP) network. FIGS. 9, 10 and 11 can be considered to illustrate some such examples.

The following description can be considered to illustrate some such examples.

In FIG. 9, the UE 150 performs evaluations of Conditional PSCell Addition and Change (CPAC) condition after block 13.

FIG. 9 can be considered to illustrate a method for Conditional PSCell Addition (CPA) scenario where SCG config is a full configuration.

In the example of FIG. 9, the UE 150 can switch between one or more CPA configurations by keeping the other CPA configurations once the UE 150 applies and executes a CPA configuration at the time of CHO execution.

In the example of FIG. 9, the UE 150 receives both the CPA configurations from the network in block 8 and stores these configurations in two separate UE variables with each of these variables marked with a “release and add” indicator for the CPA configuration part.

In the example of FIG. 9, when access towards target SN-1 fails, the UE 150 switches to the other prepared configuration by just picking the CPA configuration from the second variable and executes it. As this variable has the “release and add” indication, this automatically releases the previous configuration and switches in the new one.

FIG. 10 illustrates an example of a method 1000.

FIG. 10 can be considered to illustrate a method for Conditional PSCell Change (CPC) scenario which allows the switch between one or more CPC configurations by combining the current source SCG configuration with a target SCG specific delta configuration.

In the example of FIG. 10, the network provides the UE 150 with the baseline source SCG configuration and indicates to preserve the existing source SCG configuration when executing a delta target SCG configuration.

In case of random access failure towards the target SN 156, the UE can retrieve the stored source SCG configuration to apply another delta SCG config with respect to another target cell, as a recovery mechanism.

In the example of FIG. 10, the UE 150 receives both the CPC configurations from the network in block 8 and stores these configurations in two separate UE variables with each of these variables marked with a “release and add” indicator for the CPC configuration part.

In addition, UE 150 receives SCG configuration (or an indication to preserve current SCG configuration at the UE which is SCG0) of the current serving SN (SCG0) in block 8.

The UE 150 prepares these variables by applying the SCG specific configurations (SCG1 or SCG2) to the current configuration of the SCG (SCG0) at the UE 150.

To prevent problems after random access failure to a target SN 156, UE 150 keeps the SCG0 that is used in block 15 when it applies one of the two SCG configurations (SCG 1 in the example of FIG. 10).

Hence, when the random access fails in block 16 of the example of FIG. 10, the UE 15 switches to the other prepared configuration (delta SCG config 2) using the preserved SCG0 config and delta config of the other prepared configuration from the second variable and executes it.

As this variable has the “release and add” indication, if needed (e.g., random access failure for selected SCG config), this automatically releases the previous configuration and switches in the new one but only applying the delta on top of stored source SCG0.

FIG. 11 illustrates an example of a method 1100.

FIG. 11 can be considered to illustrate a method for CPC scenario which allows the switch between one or more CPC configurations by using a reference SCG base configuration that is applied at the time of CHO execution in case none of the CPC conditions is met. Subsequently, the UE 150 applies a target SCG specific delta configuration once a CPC condition is met later.

In the example of FIG. 11, the target MN 154 coordinates in block 3 a “base target SCG configuration” which is used as a template by SN-1 and SN-2 to prepare the “cell specific” delta configuration which is sent in block 6 and block 7:
In some examples, the target MN 154 may already have the “base target SCG configuration” which it can share to SN-1 and SN-2 in the SN addition request procedure.
In some examples, the target MN 154 receives the “base target SCG configuration” from SN-1 and shares it with SN-2.

The base configuration could be prepared by the first SN involved in DC.

There could be two ways to gather this.
a. Alternative 1: the MN 154 may ask the SN 156 to provide the base SCG config (as part of MN Initiated SN Addition Request).
b. Alternative 2: the MN 154 may provide a base config that is based on the current SN configuration (SCG0 config) and target SNs 156 provide the delta config regarding the base config.

In the example of FIG. 11, the UE 150 receives the “base target SCG configuration” which is applied by the UE 150 at time of CHO execution (at block 15). After the CHO execution, the UE 150 continues to evaluate the CPC conditions and applies one the delta configuration corresponding to SN-1 and SN-2 on top of the base configuration (which is common to all prepared target PSCells) as shown in block 17.

Examples of the disclosure are advantageous.

For example, examples of the disclosure allow a UE to recover efficiently from failure to access a target secondary node during conditional handover with dual connectivity. FIG. 12A illustrates an example of an apparatus 130. The apparatus 130 may be a controller of an apparatus or device such as a terminal node 110, for example UE 150, or network element 152, 154 and/or 156, such as an eNB or gNB. The apparatus 130 may be considered a controller.

Implementation of a controller 130 may be as controller circuitry. The controller 130 may be implemented in hardware alone, have certain aspects in software including firmware alone or can be a combination of hardware and software (including firmware).

As illustrated in FIG. 12A the controller 130 may be implemented using instructions that enable hardware functionality, for example, by using executable instructions of a computer program 136 in a general-purpose or special-purpose processor 132 that may be stored on a computer readable storage medium (disk, memory etc) to be executed by such a processor 132.

The processor 132 is configured to read from and write to the memory 134. The processor 132 may also comprise an output interface via which data and/or commands are output by the processor 132 and an input interface via which data and/or commands are input to the processor 132.

The memory 134 stores a computer program 136 comprising computer program instructions (computer program code) that controls the operation of the apparatus 130 when loaded into the processor 132. The computer program instructions, of the computer program 136, provide the logic and routines that enables the apparatus to perform the methods illustrated in the accompanying Figs. The processor 132 by reading the memory 134 is able to load and execute the computer program 136.

In examples, the apparatus 130 comprises:
at least one processor; and
at least one memory including computer program code, the at least one memory storing instructions that, when executed by the at least one processor, cause the apparatus at least to:
establish a connection towards a primary cell of a master node;
receive configuration information comprising information to allow the UE to conditionally handover the connection from the primary cell towards a target primary cell and further information to allow the UE to access a plurality of target primary secondary cells associated with the target primary cell and at least one associated access condition;
determine that a handover execution condition for the target primary cell is satisfied;
establish a connection towards the target primary cell;
send, based at least in part on at least a portion of the further information, an access request towards a first target primary secondary cell of the plurality of target primary secondary cells; and
maintain, after sending the access request towards the first target primary secondary cell, at least part of the further information to allow the UE to access at least one target primary secondary cell different to the first target primary secondary cell.

In examples, the apparatus 130 comprises:
at least one processor; and
at least one memory including computer program code,
the at least one memory storing instructions that, when executed by the at least one processor, cause the apparatus at least to:
establish a connection towards a user equipment, UE, via a source primary cell;
determine that conditional handover is to be configured at the UE;
transmit, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmit, to the UE, an indication that the current primary secondary cell configuration should be maintained as a reference primary secondary cell configuration after sending an access request towards a first target primary secondary cell.

In examples, the apparatus 130 comprises:
at least one processor; and
at least one memory including computer program code,
the at least one memory storing instructions that, when executed by the at least one processor, cause the apparatus at least to:
   establish a connection towards a primary cell of a master node;
   receive configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
   determine that a handover execution condition for the target primary cell is satisfied and that none of the conditions to access the plurality of target primary secondary cells are satisfied;
   establish a connection towards the target primary cell; and
   apply the reference primary secondary cell configuration.

In examples, the apparatus 130 comprises:
at least one processor; and
at least one memory including computer program code, the at least one memory storing instructions that, when executed by the at least one processor, cause the apparatus at least to:
   request a target secondary node to determine a reference primary secondary cell configuration;
   Receive the reference primary secondary cell configuration from the target secondary node; and
   request at least one different target secondary node to determine a delta configuration, relative to the reference primary secondary cell configuration, configured to allow a UE to access at least one target primary secondary cell associated with the at least one different target secondary node; and
   receive at least one requested delta configuration from the at least one different target secondary node.

In examples, the apparatus 130 comprises:
at least one processor; and
at least one memory including computer program code, the at least one memory storing instructions that, when executed by the at least one processor, cause the apparatus at least to:
   establish a connection towards a user equipment, UE, via a source primary cell;
   determine configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
   transmit the configuration information to the UE.

As illustrated in FIG. 12A, the computer program 136 may arrive at the apparatus 130 via any suitable delivery mechanism 162. The delivery mechanism 162 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 136. The delivery mechanism may be a signal configured to reliably transfer the computer program 136. The apparatus 130 may propagate or transmit the computer program 136 as a computer data signal.

Computer program instructions for causing an apparatus to perform at least the following or for performing at least the following:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition;

Determining that a handover execution condition for the target primary cell is satisfied;
establishing a connection towards the target primary cell;
sending, based at least in part on at least a portion of the further information, an access request towards a first target primary secondary cell of the plurality of target primary secondary cells; and
maintaining, after sending the access request towards the first target primary secondary cell, at least part of the further information to allow the UE to access at least one target primary secondary cell different to the first target primary secondary cell.

Computer program instructions for causing an apparatus to perform at least the following or for performing at least the following:
establishing a connection towards a user equipment, UE, via a source primary cell;
determining that conditional handover is to be configured at the UE;
transmitting, to the UE, configuration information comprising information to allow the UE to conditionally handover the connection from the source primary cell towards a target primary cell and further information to allow the UE to a plurality of target primary secondary cells associated with the target primary cell and at least one associated access condition; and
transmitting, to the UE, an indication that the current primary secondary cell configuration should be maintained as a reference primary secondary cell configuration after sending an access request towards a first target primary secondary cell.

Computer program instructions for causing an apparatus to perform at least the following or for performing at least the following:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determining that a handover execution condition for the target primary cell is satisfied and that none of the conditions to access the plurality of target primary secondary cells are satisfied;
establishing a connection towards the target primary cell; and
applying the reference primary secondary cell configuration.

Computer program instructions for causing an apparatus to perform at least the following or for performing at least the following:
requesting a target secondary node to determine a reference primary secondary cell configuration;
receiving the reference primary secondary cell configuration from the target secondary node; and
requesting at least one different target secondary node to determine a delta configuration, relative to the reference primary secondary cell configuration, configured to allow a UE to access at least one target primary secondary cell associated with the at least one different target secondary node; and
receiving at least one requested delta configuration from the at least one different target secondary node.

Computer program instructions for causing an apparatus to perform at least the following or for performing at least the following:
establishing a connection towards a user equipment, UE, via a source primary cell;
determining configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and transmitting the configuration information to the UE.

The computer program instructions may be comprised in a computer program, a non-transitory computer readable medium, a computer program product, a machine readable medium. In some but not necessarily all examples, the computer program instructions may be distributed over more than one computer program.

Although the memory 134 is illustrated as a single component/circuitry it may be implemented as one or more separate components/circuitry some or all of which may be integrated/removable and/or may provide permanent/semi-permanent/dynamic/cached storage.

In examples the memory 134 comprises a random access memory 158 and a read only memory 160. In examples the computer program 136 can be stored in the read only memory 158. See, for example, FIG. 12B.

In some examples the memory 134 can be split into random access memory 158 and read only memory 160.

Although the processor 132 is illustrated as a single component/circuitry it may be implemented as one or more separate components/circuitry some or all of which may be integrated/removable. The processor 132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation. This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus 130 can, in examples, comprise means for:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition;
determining that a handover execution condition for the target primary cell is satisfied;
establishing a connection towards the target primary cell;
sending, based at least in part on at least a portion of the further information, an access request towards a first target primary secondary cell of the plurality of target primary secondary cells; and
maintaining, after sending the access request towards the first target primary secondary cell, at least part of the further information to allow the UE to access at least one target primary secondary cell different to the first target primary secondary cell.

Thus, the apparatus 130 can, in examples, comprise means for:
establishing a connection towards a user equipment, UE, via a source primary cell;
determining that conditional handover is to be configured at the UE;
transmitting, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmitting, to the UE, an indication that the current primary secondary cell configuration should be maintained as a reference primary secondary cell configuration after sending an access request towards a first target primary secondary cell.

Thus, the apparatus 130 can, in examples, comprise means for:
establishing a connection towards a primary cell of a master node;
receiving configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determining that a handover execution condition for the target primary cell is satisfied and that none of the conditions to access the plurality of target primary secondary cells are satisfied;
establishing a connection towards the target primary cell; and
applying the reference primary secondary cell configuration.

Thus, the apparatus 130 can, in examples, comprise means for:
requesting a target secondary node to determine a reference primary secondary cell configuration;
receiving the reference primary secondary cell configuration from the target secondary node; and
requesting at least one different target secondary node to determine a delta configuration, relative to the reference primary secondary cell configuration, configured to allow a UE to access at least one target primary secondary cell associated with the at least one different target secondary node; and
receiving at least one requested delta configuration from the at least one different target secondary node.

Thus, the apparatus 130 can, in examples, comprise means for:
establishing a connection towards a user equipment, UE, via a source primary cell;
determining configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration, and the reference primary secondary cell configuration; and
transmitting the configuration information to the UE.

In examples, an apparatus 130 can comprise means for performing one or more methods, or at least part of one or more methods, as disclosed herein.

In examples, an apparatus 130 can be configured to perform one or more methods, or at least a part of one or more methods, as disclosed herein.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-54. (canceled)

55. A user equipment comprising:
at least one processor; and
at least one memory including computer program code,
the at least one memory storing instructions that, when executed by the at least one processor, cause the user equipment, UE, at least to:
establish a connection towards a primary cell of a master node;
receive configuration information comprising information to allow the UE to conditionally handover the connection from the primary cell towards a target primary cell and further information to allow the UE to access a plurality of target primary secondary cells associated with the target primary cell and at least one associated access condition;
determine that a handover execution condition for the target primary cell is satisfied;
establish a connection towards the target primary cell;
send, based at least in part on at least a portion of the further information, an access request towards a first target primary secondary cell of the plurality of target primary secondary cells; and
maintain, after sending the access request towards the first target primary secondary cell, at least part of the further information to allow the UE to access at least one target primary secondary cell different to the first target primary secondary cell.

56. A user equipment as claimed in claim 55, wherein sending an access request towards the first target primary secondary cell comprises sending a random access request towards the first target primary secondary cell.

57. A user equipment as claimed in claim 55, the at least one memory storing instructions that, when executed by the at least one processor, cause the apparatus at least to:
determine that access towards the first target primary secondary cell has failed; and
send, based at least in part on at least a portion of the further information that was maintained after sending the access request towards the first target primary secondary cell, an access request towards a second, different target primary secondary cell.

58. A user equipment as claimed in claim 55, the at least one memory storing instructions that, when executed by the at least one processor, cause the apparatus at least to:
when the handover execution condition for the target primary cell is satisfied, determine that none of the associated access conditions of the plurality of target primary secondary cells are satisfied; and
select a target primary secondary cell to be used as the first target primary secondary cell.

59. A user equipment as claimed in claim 55, wherein the further information comprises a plurality of configurations configured to allow the UE to conditionally access a plurality of target primary secondary cells, wherein the plurality of configurations have associated release and add indications.

60. A user equipment as claimed in claim 59, wherein the plurality of configurations configured to allow the UE to conditionally access the plurality of target primary secondary cells comprise full configurations.

61. A user equipment as claimed in claim 59, wherein the plurality of configurations configured to allow the UE to conditionally access the plurality of target primary secondary cells comprise delta configurations configured to be applied on a reference primary secondary cell configuration to obtain a full configuration.

62. A user equipment as claimed in claim 60, the at least one memory storing instructions that, when executed by the at least one processor, cause the apparatus at least to:
receive an indication that the current primary secondary cell configuration should be maintained as a reference primary secondary cell configuration after sending the access request towards the first target primary secondary cell.

63. A user equipment as claimed in claim 62, wherein the indication comprises the current primary secondary cell configuration.

64. An apparatus comprising:
at least one processor; and
at least one memory including computer program code,
the at least one memory storing instructions that, when executed by the at least one processor, cause the apparatus at least to:
establish a connection towards a user equipment, UE, via a source primary cell;
determine that conditional handover is to be configured at the UE;
transmit, to the UE, configuration information comprising information to allow the UE to conditionally handover the connection from the source primary cell towards a target primary cell and further information to allow the UE to access a plurality of target primary secondary cells associated with the target primary cell and at least one associated access condition; and
transmit, to the UE, an indication that the current primary secondary cell configuration should be maintained as a reference primary secondary cell configuration after sending an access request towards a first target primary secondary cell.

65. An apparatus as claimed in claim 64, wherein the indication comprises the current primary secondary cell configuration.

66. A user equipment comprising:
at least one processor; and
at least one memory including computer program code,
the at least one memory storing instructions that, when executed by the at least one processor, cause the user equipment, UE, at least to:
establish a connection towards a primary cell of a master node;
receive configuration information comprising information to allow the UE to conditionally handover the connection from the primary cell towards a target primary cell and further information to allow the UE to access a plurality of target primary secondary cells associated with the target primary cell and at least one associated access condition, wherein the further information comprises a plurality of delta configurations for application to a reference primary secondary cell configuration;
determine that a handover execution condition for the target primary cell is satisfied and that none of the conditions to access the plurality of target primary secondary cells are satisfied;
establish a connection towards the target primary cell; and
apply the reference primary secondary cell configuration.

67. A UE as claimed in claim 66, the at least one memory storing instructions that, when executed by the at least one processor, cause the UE at least to:
if it is determined at a later time that a condition to access a first target primary secondary cell of the plurality of target primary secondary cells is satisfied, apply a first delta configuration of the plurality of delta configurations to the reference primary secondary cell configuration to access the first target primary secondary cell of the plurality of target primary secondary cells.

68. A UE as claimed in claim 66, the at least one memory storing instructions that, when executed by the at least one processor, cause the UE at least to:
receive the reference primary secondary cell configuration, wherein the reference primary secondary cell configuration has been determined by a target secondary node.

69. An apparatus comprising:
at least one processor; and
at least one memory including computer program code,
the at least one memory storing instructions that, when executed by the at least one processor, cause the apparatus at least to:
request a target secondary node to determine a reference primary secondary cell configuration;
receive the reference primary secondary cell configuration from the target secondary node; and
request at least one different target secondary node to determine a delta configuration, relative to the reference primary secondary cell configuration, configured to allow a UE to access at least one target primary secondary cell associated with the at least one different target secondary node; and
receive at least one requested delta configuration from the at least one different target secondary node.

70. An apparatus as claimed in claim 69, the at least one memory storing instructions that, when executed by the at least one processor, cause the apparatus at least to:
transmit the received at least one requested delta configuration and the reference primary secondary cell configuration to a source master node.
